(19) United States
(12) Patent Application Publication
(10) Pub. No.: US 2024/0160771 A1
(43) Pub. Date: May 16, 2024

(54) HARDWARE-ACCELERATED HOMOMORPHIC ENCRYPTION IN MARKETPLACE PLATFORMS

(71) Applicant: GENEIAL, LLC, Missouri City, TX (US)

(72) Inventors: Adam Wesley Hansen, Missouri City, TX (US); Christopher Glenn Hansen, Provo, UT (US)

(21) Appl. No.: 18/552,637

(22) PCT Filed: Mar. 27, 2022
(86) PCT No.: PCT/US22/71369

§ 371 Date: Sep. 26, 2023

Related U.S. Application Data
(60) Provisional application No. 63/167,009, filed on Mar. 27, 2021.

(51) Int. Cl. G06F 21/62; G06F 21/60; H04L 9/00; H04L 9/08

(52) U.S. Cl. CPC G06F 21/6227; G06F 21/602; H04L 9/008; H04L 9/0863; H04L 9/50

(57) ABSTRACT

An example method includes receiving, at a CPU, a data request from a data requester to search or filter data in a repository. At least a first portion of the data is homomorphically encrypted. The method includes analyzing the stored data without decrypting the homomorphically encrypted data to determine an aggregated subset of data relevant to the data request. The analyzing includes: dispatching, from the CPU, a command to a hardware accelerator to execute an operation on the homomorphically encrypted data; executing, at the hardware accelerator, the operation on the homomorphically encrypted data; and receiving, at the CPU, an output of the execution of the operation by the hardware accelerator, where the aggregated subset of data is based on the output. The method includes providing data request results that include or are derived from the aggregated subset of data to the data requester.

### CROSS REFERENCE TO RELATED APPLICATIONS

This application claims priority to and the benefit of U.S. utility patent application No. 63/167,009, filed Mar. 27, 2021, entitled HARDWARE-ACCELERATED HOMOMORPHIC ENCRYPTION IN MARKETPLACE PLATFORMS, which is incorporated herein in its entirety.

### FIELD

The present disclosure generally relates to hardware-accelerated homomorphic encryption in marketplace platforms.

### BACKGROUND

Unless otherwise indicated herein, the materials described herein are not prior art to the claims in the present application and are not admitted to be prior art by inclusion in this section.

All types of data in numerous different fields is being generated throughout the world. Similarly, significant amounts of data are being aggregated and stored in various repositories throughout the world, including those which are commercially or governmentally managed or held. Within a given field, the accumulated data may be used in aggregate by individual repositories for various purposes. For example, in the case of genomic data, private and public repositories are utilized for discovery of disease-gene associations and potential drug targets, identification of candidates for enrollment in clinical trials, and reclassification of variants of uncertain significance (VUS) as pathogenic or benign, amongst other possibilities. The repositories may include genomic sequencing data for millions of individuals worldwide.

In parallel with the development of these different, and often isolated, data resources, there is often a demand for increased sample size by potential users of the data. Individual repositories can increase their sample size, but eventually their growth will plateau or level off as these repositories saturate in size due to market reach or political boundaries. In addition, data in a single repository may presently be individually queried, but the data in numerous repositories may not be queried together. In the latter instance, the ability to query or analyze data across disparate repositories would allow for greater power and value relative to a corresponding data request of any single repository due to increased sample size and genetic diversity. However, data sharing across repositories is not currently employed due to a number of drawbacks, including for example the common need of maintaining data privacy, whether due to legal obligations (e.g., to protect individual-level data) or business concerns. For example, searching across numerous independent data sources is not possible without compromising privacy by exposing unencrypted data to external parties.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

In an example embodiment, a method includes receiving, at a central processing unit (CPU), a data request from a data requester to search or filter data in a repository. At least a first portion of the data is homomorphically encrypted. The method includes analyzing the stored data without decrypting the homomorphically encrypted data to determine an aggregated subset of data relevant to the data request. The aggregated subset of data includes at least some of the homomorphically encrypted data. The analyzing includes dispatching, from the CPU, a command to a hardware accelerator to execute an operation on the homomorphically encrypted data. The analyzing includes executing, at the hardware accelerator, the operation on the homomorphically encrypted data. The analyzing includes receiving, at the CPU, an output of the execution of the operation by the hardware accelerator. The aggregated subset of data is based on the output. The method includes providing data request results that include or are derived from the aggregated subset of data to the data requester.

In another example embodiment, a system includes a CPU, a hardware accelerator, and one or more non-transitory computer-readable media containing instructions which, in response to being executed by the CPU, cause the system to perform or control performance of operations. The operations include receiving, at the CPU, a data request from a data requester to search or filter data in a repository. At least a first portion of the data is homomorphically encrypted. The operations include analyzing the stored data without decrypting the homomorphically encrypted data to determine an aggregated subset of data relevant to the data request. The aggregated subset of data includes at least some of the homomorphically encrypted data. The analyzing includes dispatching, from the CPU, a command to the hardware accelerator to execute an operation on the homomorphically encrypted data. The analyzing includes executing, at the hardware accelerator, the operation on the homomorphically encrypted data. The analyzing includes receiving, at the CPU, an output of the execution of the operation. The aggregated subset of data is based on the output. The operations include providing data request results that include or are derived from the aggregated subset of data to the data requester.

In another example embodiment, one or more non-transitory computer-readable media contain instructions which, in response to being executed by a CPU, cause a system that includes the CPU and a hardware accelerator to perform or control performance of operations. The operations include receiving, at the CPU, a data request from a data requester to search or filter data in a repository. At least a first portion of the data is homomorphically encrypted. The operations include analyzing the stored data without decrypting the homomorphically encrypted data to determine an aggregated subset of data relevant to the data request. The aggregated subset of data includes at least some of the homomorphically encrypted data. The analyzing includes dispatching, from the CPU, a command to the hardware accelerator to execute an operation on the homomorphically encrypted data. The analyzing includes executing, at the hardware accelerator, the operation on the homomorphically encrypted data. The analyzing includes receiving, at the CPU, an output of the execution of the operation. The aggregated subset of data is based on the output. The operations include providing data request results that include or are derived from the aggregated subset of data to the data requester.

In another example embodiment, a method includes receiving, at a CPU, a request from a requester to process data in a repository. At least a first portion of the data is homomorphically encrypted. The method includes processing the data without decrypting the homomorphically encrypted data to calculate a result of a computational operation. The processing includes dispatching, from the CPU, a command to a hardware accelerator to execute an operation on the homomorphically encrypted data to complete the processing. The processing includes executing, at the hardware accelerator, the operation on the homomorphically encrypted data. The processing includes receiving, at the CPU, an output of the execution of the operation. The method includes returning the result of the computational operation, wherein the result of the computational operation includes or is based on the output of the operation executed by the hardware accelerator.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1A illustrates an example system for secure data exchange;

FIG. 1B illustrates an example implementation of a processor system included in the system of FIG. 1A;

FIG. 2 illustrates a flowchart of an example method of secure data exchange;

FIG. 3 illustrates a flowchart of another example method of secure data exchange;

FIG. 4 illustrates a flowchart of another example method of secure data exchange; and

FIG. 5 illustrates a block diagram of an example computing system,

all arranged in accordance with at least one embodiment described herein.

### DETAILED DESCRIPTION OF SOME EXAMPLE EMBODIMENTS

The present disclosure generally relates to secure data exchange facilitated by hardware-accelerated homomorphic encryption. Homomorphic encryption is a technology that allows mathematical operations to be performed on encrypted data, resulting in an encrypted and therefore private output. Some embodiments herein implement homomorphic encryption, which allows third parties to analyze sensitive data aggregated from disparate sources without learning the contents of the data. In comparison, traditional (non-homomorphic) encryption algorithms add value by obfuscating data during storage and transit only. When traditional (non-homomorphic) encryption algorithms are used, all encrypted data must be decrypted during computation to be of any utility, thus by necessity exposing unencrypted data to the computing party. Without homomorphic encryption, aggregate analysis of data from multiple owners will always expose data to external parties, and is therefore not private. With homomorphic encryption, data can be managed and made searchable through an aggregate, centralized repository without ever exposing the actual data contents.

A common critique of homomorphic encryption is its high consumption of computing resources. Accordingly, some embodiments herein improve compute performance per unit time through hardware acceleration. Hardware acceleration can be performed via multiple strategies, including graphics processing unit (GPU) acceleration, field-programmable gate array (FPGA) acceleration, application-specific integrated circuit (ASIC) acceleration, or the like or any combination thereof. Architectural features and limitations of CPUs, including fixed numbers of cores, arithmetic logic units, floating point units, cache, and instruction set limitations, impose upper limits on CPU performance. In comparison, hardware provides opportunities to design specific circuits with custom quantities of supporting hardware units (arithmetic logic units (ALUs), floating-point units (FPUs), caches, etc.) to enable extreme parallelization, pipelining, and resource optimization. In some implementations, GPUs provide 2-3 orders of magnitude or more better performance than CPUs.

Accordingly, in some implementations, the present disclosure relates to systems and methods for facilitating hardware-accelerated analysis of data from one or more independent data sources to identify data relevant to an external party, such as a data requester, without revealing sensitive information contained in the data. The data requester may provide a data request, and the request may include queries, statistical analyses or tests, and/or training machine learning models, just to provide a few examples.

In some implementations, the present disclosure facilitates hardware-accelerated aggregate querying or analysis across data provided by multiple independent data sources while maintaining the privacy and security of each independent data source. The data may include, for example, genomic data; structured or unstructured phenotypic data such as data derived from human or other tissue samples and associated metadata, electronic medical and health records and derivatives thereof or therefrom, demographic information, medical diagnostic and billing codes (ICD codes, CPT codes), terms from computational ontologies (Human Phenotype Ontology/HPO terms), patient-reported data, health data generated by wearables or sensors, family history data, and medical imaging raw data or downstream derivative features; internet of things and smart home data stores; autonomous vehicle data; financial data; transaction data; location data; photographic data; video data; and metadata cataloguing physical products, goods, items, or services.

Genomic data may refer to data directly generated by sequencing or other nucleic acid genotyping technology, nucleic acid quantification, proteomic data generated through mass spectrometry (with or without liquid chromatography), and any and all downstream derivatives of these data, whether independently derived or analyzed jointly with other data types. In some implementations, genomic data may be derived from samples of tissues of living material, or in the field of microbiology, from an environmental sample. Microbiome may refer to the collection of microorganisms including, but not limited to, bacteria, archaea, fungi, protozoa, viruses, and phage, or more generally, to their relative abundances, detected in any sample.

In some implementations, a hardware-accelerated aggregate, privacy-preserving transactional marketplace for data where vendors make products, goods, items, or services available on a transactional basis on provider-specified or marketplace-controlled terms may also be provided.

In some implementations, data from a number of independent data sources may be received and aggregated in a repository. The data received from the independent data sources, or at least a portion thereof, may be encrypted before it is received and stored in the repository, or it may be encrypted after its receipt and before it is stored in the repository. In one aspect, a toolkit may be provided to the independent data source(s) and the toolkit may be used by the independent data source(s) to encrypt data before it is received. In some implementations, the data which is encrypted may be homomorphically encrypted, and the homomorphic encryption may occur before the data is received and stored. By way of example, all or part the encrypted data stored may be fully homomorphically encrypted (FHE) or all or part of the encrypted data stored may be partially homomorphically encrypted. Generally speaking, homomorphic encryption facilitates mathematical operations to be performed on encrypted data, resulting in an encrypted and therefore private output. As such, a third party external to the independent data sources and the repository may analyze sensitive data aggregated from the independent data sources without the sensitive contents of the data being revealed. Similarly, the repository may provide a trusted approach for querying or analyzing domain-specific data, powered by hardware-accelerated homomorphic encryption, enabling the independent data sources to participate in data exchange on their own terms. Similarly, the independent data sources may securely sell specific data entries without exposing their entire data asset to the data requester(s).

Data requests, including queries or analyses for example, may be received from a third party, such as a data requester, and the data requests may be run against the aggregate data stored in the repository without decrypting the data. Hardware acceleration may be implemented to reduce the computational expense compared to running such data requests without hardware acceleration, e.g., on a CPU. In some implementations, after the data has been analyzed and the data requester determines at least some portion of the data is relevant or valuable for their objectives, an encrypted result including the portion of the data deemed relevant to the third party may be delivered to the data requester, and one-time decryption keys may be passed from the independent data sources responsible for providing the respective data to the data requester. In some implementations, a request for the encrypted result including the portion of the data deemed relevant to the third party may be delivered to the one or more independent data sources through the repository, the encrypted result may be provided through the repository to the data requester, and the one-time decryption key may also be provided by the one or more independent data sources to the data requester through the repository.

Alternatively or additionally, each independent data source responsible for providing the data to the repository that is included within the data deemed relevant to the data requester may be determined, and the independent data sources may be notified of such determination along with an identification of the respective data each has provided that is included in the data deemed relevant to the data requester. Each independent data source so notified may decrypt its relevant data and then re-encrypt its relevant data with a public key provided by the data requester. The re-encrypted data may be returned to and received by the repository, and the re-encrypted data may be provided to the data requester from the repository for decryption with a private key corresponding to the public key.

In some implementations, the independent data sources may each encrypt data with a common homomorphic encryption algorithm, although potentially with separate keys, or with one or more unique, secret transformation functions applied to their data before or after encryption. These data may then be aggregated at the repository into a single database with a consistent schema such as a set of columns or fields, with rows potentially encrypted with different keys, based on the original independent data source of origin. Information regarding the independent data source of origin for particular data may be unencrypted or encrypted, with or without homomorphic encryption. Queries, analysis, or other mathematical operations performed against this aggregate database may yield encrypted output data, with keys for decryption dependent on the specific rows returned and the key used to encrypt those rows, or if a single key is used together with unique, secret transformation functions applied to the data, the corresponding function to reverse each respective transformation may be applied. In the case where aggregate functions are applied across multiple rows, returning a function of multiple rows, the decryption key or transformation function corresponding to each individual row contributing to the aggregate function may be provided to decrypt the final output.

Optionally, automatic or manual decryption, or transmission of encrypted data along with a relevant one-time decryption key, included in the data deemed relevant to the data requester, may be performed in response to receiving confirmation of completion of a financial transaction. For example, in response to receiving confirmation of completion of a financial transaction, an independent data source may decrypt certain data and re-encrypt that data with a public key provided by the data requester. Alternatively, in response to receiving confirmation of completion of a financial transaction, an independent data source may deploy one-time keys for decrypting data to the data requester. In some implementations, this function may be enforced through the utilization of smart contracts which implement computer protocols intended to digitally facilitate, verify, or enforce the negotiation or performance of a contract. These computer protocols may facilitate the transfer of digital assets between parties under agreed-upon stipulations or terms. In other words, they are agreements to exchange goods, services, or money that will automatically execute, without third party oversight, so long as established criteria are met. They may or may not involve cryptocurrencies or blockchain technology. For example, where standard private keys are used to decrypt data, a smart contract may force an independent data source to decrypt data (so long as the private key is still provided) upon verification that the data is in accordance with pre-determined eligibility criteria, and upon verification that payment has been received from a third party in exchange for access to the decrypted data or data components. However, forms in which smart contracts or blockchain are not used to verify, enforce, or otherwise execute the contract or agreement are also possible.

The data stored in the repository may be subject to differential encryption where some information is encrypted and some is not, or where different levels of encryption are used with different types of data. For example, in some implementations, a file such as Variant Call Format (VCF) file for example may be analyzed to identify sensitive and non-sensitive data, and only the sensitive data may be homomorphically encrypted.

One or more indexes of the data, including homomorphically encrypted data, stored on the repository may also be created. Hardware acceleration may be implemented to create the index(es). An index may be created for individual component encrypted databases or for the aggregate database. In some implementations of indexing, data may first be sorted prior to encryption, then an index may be created as a separate database containing primary keys and pointers to the data. In another form of indexing, data may be sorted after encryption. Indexing may use ordering of values or hash functions, and may be clustered (e.g. primary indexing), non-clustered (e.g. secondary indexing), or multilevel.

A number of precalculated SELECT outputs or fetches of data in the repository may be generated from asynchronous queries or data requests on homomorphically encrypted data. Hardware acceleration may be implemented to generate the precalculated SELECT outputs or fetches of data. A server can execute a multitude of various SELECT statements or data retrieval functions against a homomorphically-encrypted database and store the resulting outputs in a lookup table, hash table, distinct database table, or similar structure for faster retrieval later in the event that a similar or exact later query or data request is found to match entries in the prefetched set of outputs. The process of pre-calculating and caching outputs may enable quick functionality when such homomorphically-encrypted data is deployed in real time. In the case of genomic data for example, the locations within the repository of variants may be precomputed for fast retrieval when they are needed during live data requests. Stated alternatively, the locations of variants or other data may be predetermined and storing the predetermined locations may provide a faster cache or lookup table. These predetermined locations may be indexed while maintaining the privacy and security of customer data, thereby preserving the benefits of homomorphic encryption while further increasing real-world, real-time operating speed.

In another embodiment, with or without utilizing homomorphic encryption, a central node or repository may receive data requests from one or more data requesters, translate the data requests into a set of all possible resulting data, and pass the modified data requests on to independent data sources. The independent data sources may then execute and log the data requests, and each may independently return their results (as appropriate) to the central node, which in turn returns aggregate results to the data requester. In some implementations, when this embodiment is implemented in connection with genomic data, input filter-based data requests of genomic annotation parameters may first query or analyze an aggregate set of all possible variants (whether universal or specific to a given data set) at the central node. This initial query or analysis may then be translated or decomposed into a set of all possible genomic variants matching input criteria. The independent data sources may then be individually or aggregately queried or analyzed as to whether they contain any samples or instances of individuals harboring genetic variants in the intermediate set. Results may be first returned to the central data request coordinating node prior to aggregate analysis and return of results to the data requester.

In one aspect, the instances of the one or more genetic variants may include genomic and phenotypic data for individuals known to harbor or possess specific genetic variants. However, it is also contemplated that a data request may relate to a query or analysis across aggregate data such as a summary of statistics across a group or “cohort” of people/samples with features (genomic, phenotypic/biomedical, or otherwise) known to match input filter parameters of the data requester(s). For example, a data requester might want to search for people with a specific rare disease, and may also want access to an interactive dashboard of charts, summary statistics, etc., generated from analysis of this ‘on-demand cohort’ (matching input criteria).

With respect to genomic data for example, translation of the data requests into a set of all possible resulting data may involve a repository where variant-level and gene-level annotation data (e.g. allele frequency, predicted pathogenicity, known phenotypic associations, gene expression levels, etc.) for all or any number of variants and genes is catalogued. In this form, the repository may, in combination with sample-level genotypic information, allow for efficient, on-demand annotation of genes and variants downstream of executing SQL-like data requests searching for variants meeting specified criteria. Alongside these annotations, the repository may include a unique-variant table, initially consisting of all possible single-nucleotide variants (SNVs) (as this is a fixed set of variants) and/or all insertions or deletions of bases (INDELs) previously reported in a large, publicly available population dataset. Scripts may be provided which utilize these variant and annotation databases to decompose a given filter-based genomic data request into an output set of all possible matching variants. These scripts may reduce the complexity of any given data query or request by decomposition into multiple, more basic data requests. Various database design parameters may be adapted to optimize query or analysis performance and speed.

In some implementations, the subject matter disclosed herein may provide rare disease researchers or others with a search engine for variants meeting specified criteria such that a marketplace for genomic and or medical/health data or related tissue samples and associated metadata may be provided. The search engine may return an entire dataset if no criteria are specified in a search or filter and/or if all specified criteria or filters are removed. In this implementation, homomorphic encryption libraries may be used to construct a deterministic database capable of performing conjunctive match lookup queries or data requests for generic data given SQL-like syntax. By way of example, variant queries or data requests with complex annotation-based criteria may be executed (e.g., select missense variants where minor allele frequency <0.001, REVEL score >0.9, and are highly expressed in the lung) and simple variant lookup queries or data requests may be executed. Indexing may be utilized to optimize query or analysis performance. Scripts may encrypt VCF files (genomic variant data) and structured phenotypic data and ingest them into a fully homomorphic encryption (FHE) database.

This or other databases may be implemented alongside a tool that translates genomic filter-based queries or data requests into corresponding sets of possible variants. An unencrypted or non-homomorphically encrypted unique-variant database may be deployed, initially consisting of all possible SNVs, and all INDELs catalogued in the genome aggregation database (gnomAD). An inclusive set of variant-level and gene-level annotations may be curated, aggregated, and formatted. Scripts may utilize these variant and annotation databases to translate and/or decompose a given filter-based genomic query or data request into a set of all possible variants matching input criteria. This query/data request translation and/or decomposition tool may then facilitate annotation filter-based querying or analysis of a homomorphically encrypted genomic database, reducing the computational load of the homomorphically encrypted genomic database.

Homomorphically encrypted query or data request outputs can be decrypted where source data is independently encrypted by independent data providers. The filter-based querying or analysis previously described can return decrypted results from queries or analysis of source data composed of any number of independent genomic or medical/health data repositories. Individual decryption (private) keys remain secret to each data store. Data requests may be routed first through the unencrypted unique-variant database and subsequently through a homomorphically encrypted genomic database corresponding to each data store. The encrypted results from each homomorphically encrypted database may be returned to the respective data store keyholders, which in turn decrypt the results, encrypt the results with a public key provided by the data requester, and securely return the encrypted result to the central server for forwarding to the data requester, who can decrypt it with their private key.

The platform may be portable (e.g. cloud-based and/or containerized) and may allow for data harmonization, or consistent pre-processing of data allowing for interoperability. An encryption key manager may be utilized which may have a capability to issue a series of one-time access keys to decrypt output data from homomorphically encrypted queries. At each independent data store, a standard repository communication node may be deployed which pushes sensitive data (that may be homomorphically encrypted) and other data (that may have standard encryption) to a centralized coordination service, and receives from the same service both 1) payments and 2) requests to decrypt data given an end-user-data-requester-provided key, or requests that decryption keys be sent to the data requester.

An optional front-end web application allows data requesters to interface with the repository or central coordination node. This may allow for the exchange of decryption keys from data repositories to data requesters, without keys being accessible to the central server. Otherwise, it may receive encryption keys from the data requester to pass to the data repositories (preferably by way of the repository or central coordination node), who in turn decrypt output data received from the central coordination node or repository and re-encrypt with the data requester provided key, returning output data to the data requester (e.g., by way of the central coordination node or repository), who in turn decrypts final output data with their private key. Financial transactions may be managed through the central coordination node or repository. Smart contracts may or may not be used to enforce data encryption, decryption, and/or transfer upon fulfillment of pre-determined terms, which may include confirmation of receipt of payment (in any currency or cryptocurrency), approval of query or data request syntax, recognition of data requester authorization and/or credentials, and/or other pre-determined terms.

Optional blockchain integration features may enable historical tracking of ownership and/or viewership of data, automatic encryption and/or decryption triggered by specific events, automated auditing, granular access (granting or revocation) control, federated identity management, or cryptocurrencies enabling buying and selling of marketplace assets without the use of fiat or governmental currencies.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

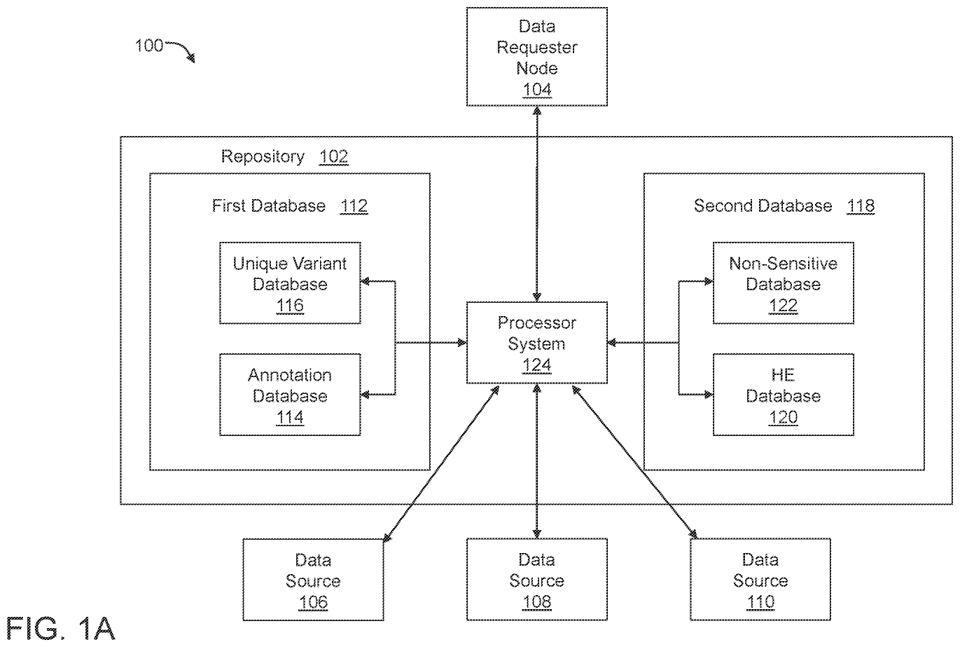

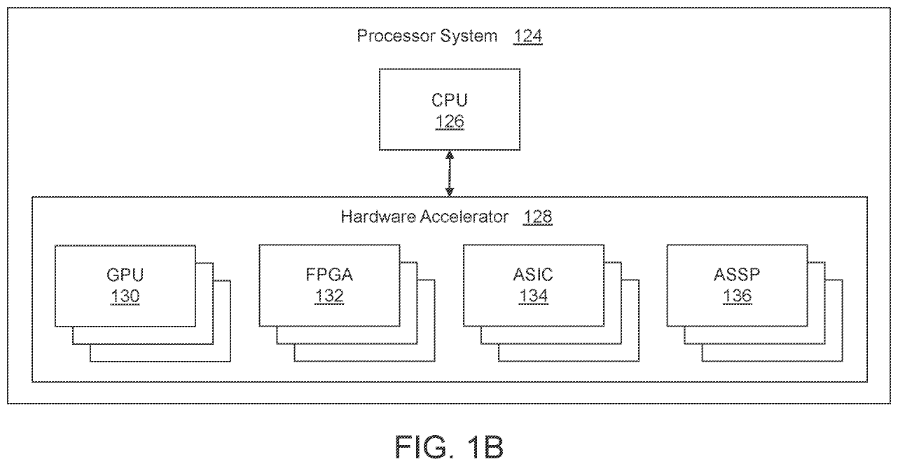

FIG. 1A illustrates an example system 100 for secure data exchange, arranged in accordance with at least one embodiment described herein. The system 100 may generally include a repository 102, a data requester node 104 (or “data requester 104”), and one or more data sources 106, 108, 110. In FIG. 1A for example, the data requester 104 may gain access to the repository 102 through a web application or other application interfacing with the data requester 104. The data requester 104 may include a computing device or node and/or a person or other entity operating the computing device or node to submit data requests to the repository 102. The repository 102 includes a first database 112 which includes a sub-database 114 and a sub-database 116. In the illustrated form, the sub-database 114 is representative of an annotation database and the sub-database 116 is representative of a unique variant database. The repository 102 also includes a second database 118 which includes a sub-database 120 and a sub-database 122. In the illustrated form, the sub-database 120 is representative of a database storing homomorphically encrypted data provided by independent data sources 106, 108, 110 and the sub-database 122 is representative of a database storing data provided by independent data sources 106, 108, 110 which is deemed not sensitive. The data in the sub-database 122 may not be encrypted, or it may be encrypted but at a level lower than the data in the sub-database 120. In one form, the homomorphically encrypted data stored in the sub-database 120 may be homomorphically encrypted by the independent data sources 106, 108, 110 before it is provided to the repository 102, although forms in which all or part of this data is homomorphically encrypted following its receipt at the repository 102 are also possible. Similarly, the data in the sub-database 122, if encrypted, may be encrypted before or after deposit in the repository

The repository 102 may also include a processor system 124. When the repository 102 receives data requests from the data requester 104, the processor system 124 may first relay the data requests to the database 112 where the data request or data requests are decomposed into an output set of all possible variants meeting the specified input criteria. This simplified, equivalent data request may then be relayed to the sub-database 120 which may be performance-optimized by storing only linking information between variant and sample identifiers (or between sample and phenotype identifiers). Alternatively or additionally, the processor system 124 may perform the decomposition to generate the simplified, equivalent data request to query the sub-database 120.

The number of samples harboring variants matching the data requester 104 search criteria, optionally along with pricing information, may then be returned to the data requester 104, at which point the data requester 104 may decide whether to move forward with purchasing the results. While not previously discussed, in some forms the data request(s) from the data requester 104 may be private such that the repository 102, and the processor system 124 thereof, are blind as to the identification of the data requester 104 and/or the contents of the data request(s).

If the data requester 104 elects to purchase (e.g., deems the results relevant to their objectives), the processor system 124 may coordinate procuring readable results for the data requester 104 without exposing results to itself, where the results may be from any number of the independent data sources 106, 108, 110. In some implementations, the repository 102 may receive a standard public key from the data requester 104. The homomorphically encrypted results may then be joined with the full variant information stored in the sub-database 122, and both the public key and the results may be sent to the relevant ones of the independent data sources 106, 108, 110 for decryption (e.g., using decryption keys of the independent data sources 106, 108, 110) and re-encryption using the standard public key. The public key may be used for re-encrypting the results with homomorphic encryption (either full or partial) or other encryption. The re-encrypted results may then be passed through the repository 102 and delivered to the data requester 104, who can decrypt the purchased results with their corresponding private key. The private key used by the data requester 104 is the private key that decrypts data encrypted with the public key provided by the data requester 104 to the repository 102. In this and some other implementations, the repository 102 may be unable to view any sensitive data provided by one or more of the independent data sources 106, 108, 110 and forwarded to the data requester 104. Alternatively, the relevant ones of the independent data sources 106, 108, 110 may each provide a one-time decryption key to the repository 102 and the repository 102 may forward the relevant results along with the one-time decryption key of each of the relevant ones of the independent data sources 106, 108, 110 to the data requester 104. Alternatively, the relevant ones of the independent data sources 106, 108, 110 may each provide a one-time decryption key, along with the results relevant to the data request(s), directly to the data requester 104, and/or the one-time decryption key, along with the results relevant to the data request(s), may be provided to an independent third party (outside of the repository 102) which may then forward the same on to the data requester 104.

As another alternative, the data requester 104 may create a public-private key pair and retain the private key. The public key could be forwarded from the data requester 104 to the repository 102 where the processor system 124 forwards the same public key to one or more of the independent data sources 106, 108, 110. One or more of the independent data sources 106, 108, 110 may then issue one-time decryption keys, and those keys may be encrypted with the public key provided by the data requester 104. The one or more of the independent data sources 106, 108, 110 may forward the encrypted key to the repository 102, and the processor system 124 may forward the encrypted key package(s) to the data requester 104. The data requester 104 may use the private key to decrypt the key package(s) to obtain the one-time keys such that the one-time keys may be utilized to decrypt the purchased results of the initial data request(s).

Additions, omissions, modifications, etc. may be made to the system 100 of FIG. 1A. For example, the system 100 may include two or more data requesters 104; one, two, four, or more independent data sources 106, 108, 110, two or more processor systems, or the like. Alternatively or additionally, the first database 112 and/or the second database 118 may include fewer or more sub-databases than shown, such as zero, one, three, or more sub-databases.

FIG. 1A as illustrated depicts a centralized architecture in which at least some homomorphically encrypted data from the data sources 106, 108, 110 is stored at the repository 102, e.g., in the second data base 118 and/or specifically in the sub-database 120. Embodiments described herein may alternatively or additionally include a pseudo decentralized architecture and/or a decentralized architecture. In the pseudo decentralized architecture, the repository 102 does not store any homomorphically encrypted data of the data sources 106, 108, 110 but may have read access to homomorphically encrypted data at the data sources. Thus, the repository 102 may still process (e.g., search, filter, analyze) the homomorphically encrypted data at the data sources 106, 108, 110 without decrypting it. As such, the repository 102 may process requests from the data requester node 104 in generally the same manner as in the centralized architecture. In the decentralized architecture, the repository 102 does not store any homomorphically encrypted data of the data sources 106, 108, 110 and does not have read access to any data at the data sources. Instead, any queries received by the repository 102 from the data requester node 104 may be passed to the data sources 106, 108, 110 and each data source 106, 108, 110 may perform the query and return the results to the repository 102. The repository may then aggregate results from the data sources 106, 108, 110, otherwise process the results, and return the results to the data requester 104.

FIG. 1B illustrates an example implementation of the processor system 124 of FIG. 1A, arranged in accordance with at least one embodiment described herein. In general, the processor system 124 may include a CPU 126 and one or more hardware accelerators 128. For example, the hardware accelerator 128 may include one or more GPUs or GPU accelerators 130, one or more FPGAs or FPGA accelerators 132, one or more ASICs or ASIC accelerators 134, one or more application-specific standard products (ASSPs) or ASSP accelerators 136, one or more other hardware accelerators, and/or any combination of the foregoing.

In operation, the processor system 124 and particularly the CPU 126 may perform or control performance of analysis (e.g., statistical tests, mathematical operations), search, and/or retrieval operations on homomorphically encrypted data. For example, the CPU 126 may receive data requests, e.g., from the data requester 104, to search or filter data in the repository 102, including at least some data that is homomorphically encrypted. The processor system 124 may then analyze the stored data without decrypting the homomorphically encrypted data to determine an aggregated subset of data relevant to the data request where the aggregated subset of data includes at least some of the homomorphically encrypted data. The processor system 124 may then provide data request results that include or are derived from the aggregated subset of data to the data requester.

In some embodiments, the analysis of the stored data may be performed by one or both of the CPU 126 and the hardware accelerator 128. The analysis may include one or more of the following. For example, the CPU 126 may identify from the data request one or more operations to service the data request and may dispatch a command to the hardware accelerator 128 to execute the one or more operations on the homomorphically encrypted data. The one or more operations identified by the CPU may be computationally expensive operations. Computational expense may be determined or considered in terms of processor cycles, power consumption, or other metric. Thus, a “computationally expensive operation” may refer to an operation that when executed by a hardware accelerator takes fewer processor cycles and/or less power than when executed by a CPU. The hardware accelerator 128 may execute the operation on the homomorphically encrypted data. An output of the operation may be provided by the hardware accelerator 128 to the CPU 126. The aggregated subset of data determined by the processor system 124 may be based on the output of the operation executed by the hardware accelerator 128. The term “based on” in this sense may indicate the aggregated subset of data includes or is derived, in whole or in part, from the output of the operation.

In some embodiments, the CPU 126 may dispatch two or more commands to the hardware accelerator 128 or to two or more hardware accelerators 128 to execute two or more operations on the homomorphically encrypted data and the hardware accelerator 128 or the two or more hardware accelerators 128 may execute the two or more operations. In this and other embodiments, CPU 126 may aggregate the outputs of the two or more operations executed by the one or more hardware accelerators 128 and the aggregated subset of data determined by the processor system 124 may be based on the aggregated outputs of the operations.

GPUs, such as the GPUs 130 of FIG. 1B, provide accessible platforms to experiment with accelerating various algorithms implemented on CPUs. GPUs are also very highly utilized in production environments where both high performance and some flexibility may be required.

Generally, performance of a processor system, such as the processor system 124, depends on multiple factors. First, the underlying hardware determines how many instructions per cycle can be executed, and how quickly each cycle executes, as well as the power utilized per cycle. Secondly, the software being run can contribute to poor performance. Often, sub-optimal software architecture, design, and implementation contribute to unnecessarily long execution time. Accordingly, some embodiments herein may improve or optimize performance using hardware accelerators 128 and/or other techniques. Hardware acceleration according to some embodiments herein may reduce average power consumed per operation by completing many operations in parallel and reducing total computational time.

Performance improvements or optimizations implemented according to some embodiments herein may involve a multi-pronged approach. First, codebase analysis tools may be deployed to characterize performance of a program run on a given hardware system. The results of this characterization may include or indicate how much time the program spends in specific functions and how often those functions are run. Next, the codebase may be analyzed, e.g., by a software engineer, to determine how to restructure loops and control statements and reduce algorithmic time-complexity. After optimizing the codebase and eliminating unnecessary complexity, the engineer may turn to compiler optimizations to further improve the runtime performance of compiled code.

Some embodiments herein characterize a codebase of the repository 102 to measure CPU utilization of various components of the codebase, including, e.g., the amount of time consumed within functions supporting implemented phenotypic data structures, as well as functions implementing homomorphic encryption. For example, the performance of one or more functions within repository 102 may be tested as the first and/or second databases 112, 118 scale in size. Simulated data may be added to supplement real patient data to model how various components of the codebase perform across a range of orders of magnitude, such as 100, 1,000, 10,000, 100,000, 1,000,000, and 10,000,000 individuals.

The testing of the codebase to determine execution time and power utilization may yield information for the purposes of other improvements or optimization efforts, including hardware acceleration among potentially others. For example, this information may be used to improve or optimize the codebase to eliminate unnecessary complexity and improve runtime performance. Subsequently, improvement and/or optimization efforts may move toward compiler optimization, where the compiled codebase may be characterized using various compiler options with performance improvements being documented and best flags being identified to use for compilation.

One or more of the foregoing performance characterizations may be used to identify the most computationally expensive operations occurring regularly during runtime at the repository 102 as targets for hardware acceleration. Hardware development is a more involved, slower process than software development, typically requiring more planning and testing resources than software. Planning the hardware development may include architecting the targeted algorithms to determine their proper representation in hardware, as well as resource planning and allocation.

After hardware project planning, GPU hardware development environments may be set up, which may involve joining the NVIDIA Developer Program and installing and configuring NVIDIA software development kits (SDKs) for GPU programming in some embodiments. After setting up the development environments, system models may be implemented to begin development on the accelerated algorithms.

The next stage may involve development work, including digging into implementation details and iterating through designs. In parallel with design work, testing infrastructure may also be implemented. Tests that verify both an accuracy of computations at a block-level and characterize a runtime of a new algorithm implementation may be implemented. After design and block-level testing has been completed, the GPU development environment may be connected to the rest of the software system. System-level verification (functionality and performance testing) and validation (assuring the design meets specifications) on the entire GPU accelerated system may then be implemented. Instead of or in addition to the GPU acceleration, embodiments herein may implement FPGA acceleration, ASIC acceleration, and/or ASSP acceleration.

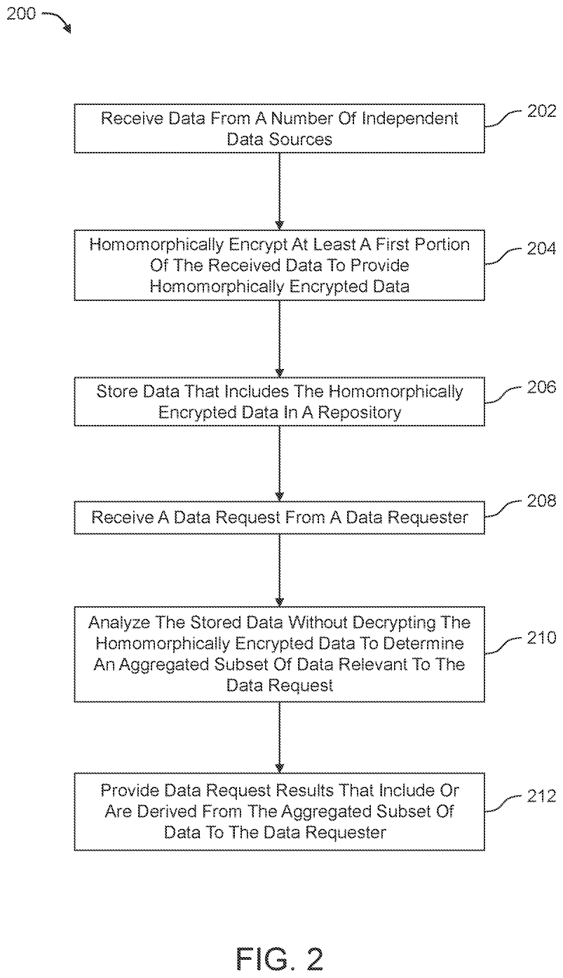

FIG. 2 illustrates a flowchart of an example method 200 of secure data exchange, arranged in accordance with at least one embodiment described herein. The method 200 may be performed or controlled by any suitable system, apparatus, or device. For example, the repository 102 or the processor system 124 of FIG. 1A may perform or direct performance of one or more of the operations associated with the method 200 and/or may implement hardware acceleration to reduce power consumption and/or total computational time. The method 200 may include one or more of blocks 202, 204, 206, 208, 210, and/or 212.

At block 202, the method 200 may include receiving data from a number of independent data sources. For example, the repository 102 of FIG. 1A may receive data from the data sources 106, 108, and/or 110. Block 202 may be followed by block 204.

At block 204, the method 200 may include homomorphically encrypting at least a first portion of the received data to provide homomorphically encrypted data. In some embodiments, some or all of the homomorphic encryption may be facilitated through hardware acceleration, e.g., by one or more of the hardware accelerators 128 performing one or more operations involved in the homomorphic encryption. Block 204 may be followed by block 206. However, in some forms the block 204 may be absent and the number of independent data sources may homomorphically encrypt all or a portion of the data they provide before it is provided. In these forms for example, the sequence of the actions performed at block 202 and block 204 could be, in essence, reversed.

At block 206, the method 200 may include storing data that includes the homomorphically encrypted data in a repository. For example homomorphically encrypted data of the data sources 106, 108, and/or 110 may be stored in the sub-database 120 and/or their non-sensitive, unencrypted, and/or data encrypted with a lower encryption may be stored in the sub-database 122. Block 206 may be followed by block 208.

At block 208, the method 200 may include receiving a data request from a data requester. For example, the data request may be received by the repository 102 from and/or through the data requester 104. Block 208 may be followed by block 210.

At block 210, the method 200 may include analyzing the stored data without decrypting the homomorphically encrypted data to determine an aggregated subset of data relevant to the data request. The aggregated subset of data may include at least some of the homomorphically encrypted data. Alternatively or additionally, the aggregated subset of data may include homomorphically encrypted data obtained by homomorphically encrypting at least some data received from at least two of the data sources. In some embodiments, the analysis at block 210 may be facilitated through hardware acceleration, e.g., by one or more of the hardware accelerators 128 performing one or more operations involved in the analysis. Block 210 may be followed by block 212.

At block 212, the method 200 may include providing results that include or are derived from the aggregated subset of data to the data requester.

In some embodiments, the method 200 may further include receiving a request from the data requester for decryption of the at least some of the homomorphically encrypted data included in the aggregated subset of data. For example, the data requester may request decryption of the homomorphically encrypted data included in the aggregated subset of data after seeing a purchase price. The method 200 may further include providing a decryption key from at least one of the independent data sources to the data requester. The aggregated subset of data may include at least some data from the at least one independent data source that has been homomorphically encrypted and/or the decryption key may include a one-time decryption key.

Alternatively or additionally, the method 200 may further include identifying the independent data sources having homomorphically encrypted data in the aggregated subset of data and notifying the identified independent data sources of the request from the data requester. The identified independent data sources may be notified by sending their respective homomorphically encrypted data to each independent data source. The method 200 may further include receiving re-encrypted data from the identified independent data sources. The re-encrypted data may have the homomorphic encryption removed and may be re-encrypted with a public encryption key provided by the data requester such that the data requester may receive and decrypt the re-encrypted data using a corresponding private key of the data requester. The results provided to the data requester may include the re-encrypted data in this and/or other implementations.

In some implementations, the method 200 may further include running one or more indexing queries or analysis to identify one or more locations of certain homomorphically encrypted data stored in the repository and storing the one or more locations. Alternatively or additionally, the method 200 may further include identifying the one or more locations when the data request from the data requester is the same or similar to the one or more indexing queries. This may result in quicker data request results.

In some implementations, the method 200 may further include non-homomorphically encrypting or partially homomorphically encrypting at least a second portion of the data received from the independent data sources. Alternatively, the independent data sources may non-homomorphically encrypt or partially homomorphically encrypt at least a second portion of its respective data before it is provided. By way of example, less sensitive data may be non-homomorphically encrypted or partially homomorphically encrypted. Thus, the first portion of the data received from the independent data sources may have a higher sensitivity level than the second portion of the data received from the independent data sources.

In some implementations, the method 200 may further include identifying from the data request received from the data requester one or more types of data to be identified from the stored data and analyzing the stored data to determine if the one or more types of data is included therein. The one or more types of data to be identified from the stored data may include one or more genetic variants and analyzing the stored data may include determining if the homomorphically encrypted data includes any instances of the one or more genetic variants.

In some implementations, the stored data may include genomic data and/or phenotypic data. Alternatively or additionally, the stored data includes information relating to physical assets for sale.

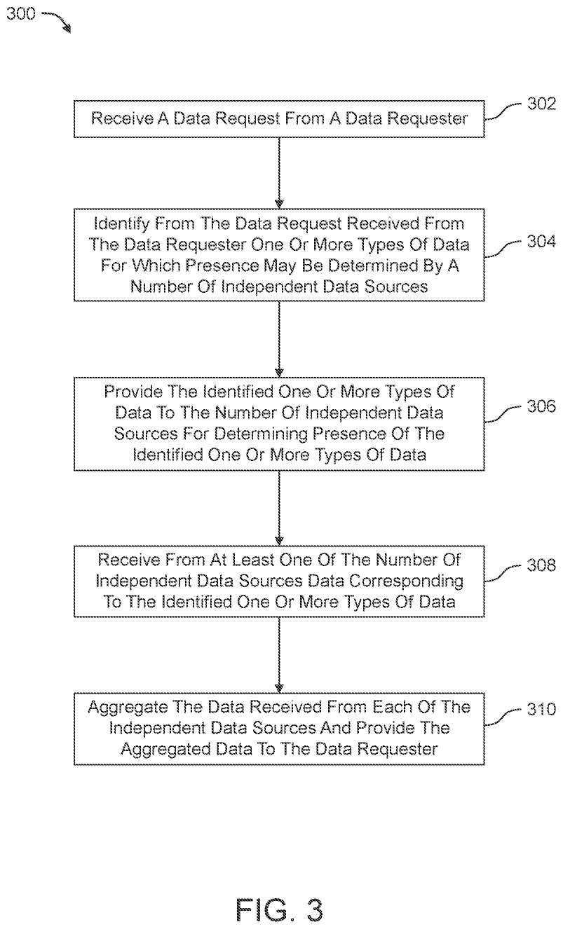

FIG. 3 illustrates a flowchart of another example method 300 of secure data exchange, arranged in accordance with at least one embodiment described herein. The method 300 may be performed or controlled by any suitable system, apparatus, or device. For example, the repository 102 or the processor system 124 of FIG. 1A may perform or direct performance of one or more of the operations associated with the method 300. The method 300 may include one or more of blocks 302, 304, 306, 308, and/or 310.

At block 302, the method 300 may include receiving a data request from a data requester. For example, the data request may be received by the repository 102 from and/or through the data requester 104. Block 302 may be followed by block 304.

At block 304, the method 300 may include identifying from the data request received from the data requester one or more types of data for which presence may be determined by a number of independent data sources. Block 304 may be followed by block 306.

At block 306, the method 300 may include providing the identified one or more types of data to the number of independent data sources for determining presence of the identified one or more types of data. Block 306 may be followed by block 308.

At block 308, the method 300 may include receiving from at least one of the independent data sources data corresponding to the identified one or more types of data. Block 308 may be followed by block 310.

At block 310, the method 300 may include aggregating the data received from each of the independent data sources and providing the aggregated data to the data requester.

In some implementations, the one or more types of data to be identified from the data request includes a genetic variant. Alternatively or additionally, the data received from the at least one of the number of independent data sources includes instances of the genetic variant, or additional genetic data, phenotypic data, or other metadata associated with samples or individuals identified as possessing the genetic variant.

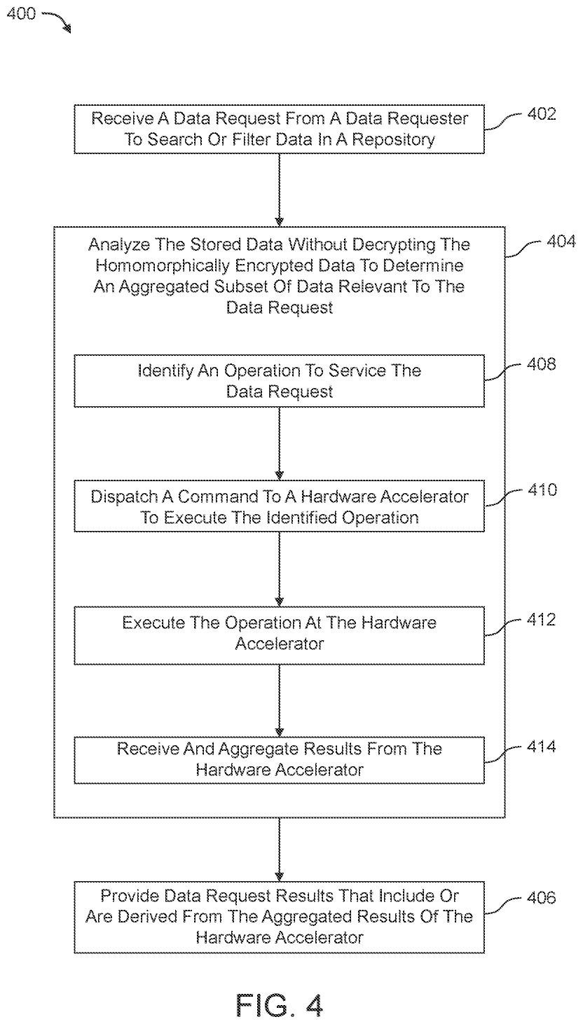

FIG. 4 illustrates a flowchart of another example method 400 of secure data exchange, arranged in accordance with at least one embodiment described herein. The method 400 may be performed or controlled by any suitable system, apparatus, or device. For example, the repository 102 or the processor system 124 of FIG. 1A may perform or direct performance of one or more of the operations associated with the method 400 and/or may implement hardware acceleration to reduce power consumption and/or total computational time. The method 400 may include one or more of blocks 402, 404, 406, 408, 410, 412, and/or 414.

At block 402, the method 400 may include receiving a data request from a data requester to search or filter data in a repository. At least a first portion of the data in the repository may be homomorphically encrypted. In an example, the data request may be received by the repository 102 from and/or through the data requester 104 to search or filter data in the second database 118. Block 402 may be followed by block 404.

At block 404, the method 400 may include analyzing the stored data without decrypting the homomorphically encrypted data to determine an aggregated subset of data relevant to the data request. The aggregated subset of data may include at least some of the homomorphically encrypted data. Alternatively or additionally, the aggregated subset of data may include homomorphically encrypted data obtained by homomorphically encrypting at least some data received from at least two of the data sources. Block 404 may be followed by block 406.

At block 406, the method 400 may include providing results that include or are derived from the aggregated subset of data to the data requester.

In some embodiments, the analysis at block 404 may be facilitated through hardware acceleration, e.g., by one or more of the hardware accelerators 128 performing one or more operations involved in the analysis. Alternatively or additionally, the analysis at block 404 may include one or more of blocks 408, 410, 412, and/or 414.

At block 408, the method 400 may include identifying an operation to service the data request. For example, the CPU 126 may identify the operation, e.g., as an operation that may be executed by the hardware accelerator 128 (e.g., by the GPU 130, the FPGA 132, the ASIC 134, or the ASSP 136) more efficiently than by the CPU 126. Block 408 may be followed by block 410.

At block 410, the method 400 may include dispatching, from the CPU, a command to a hardware accelerator to execute the operation on the homomorphically encrypted data. For example, the CPU 126 may dispatch a command to the hardware accelerator 128 (e.g., the GPU 130, the FPGA 132, the ASIC 134, or the ASSP 136) to execute the operation. Block 410 may be followed by block 412.

At block 412, the method 400 may include executing the operation at the hardware accelerator. For example, the hardware accelerator 128 (e.g., the GPU 130, the FPGA 132, the ASIC 134, or the ASSP 136) may execute the operation. Block 412 may be followed by block 414.

At block 414, the method 400 may include receiving an output of the execution of the operation by the hardware accelerator on the homomorphically encrypted data at the CPU. The CPU may determine the aggregated subset of data based on the output. In some embodiments, the CPU 126 dispatches two or more commands to the hardware accelerator 128 (or to two or more of the hardware accelerators 128) and execution of each of the operations generates a corresponding output. The resulting outputs may be received and aggregated by the CPU 126. Alternatively or additionally, the CPU 126 may determine the aggregated subset of data based on the aggregated outputs.

In some embodiments of the method 400, the hardware accelerator includes a GPU, an FPGA, an ASIC, or an ASSP. For example, the hardware accelerator may include the GPU 130, the FPGA 132, the ASIC 134, or the ASSP 136.

In some embodiments, the method 400 may further include receiving a decryption request from the data requester for decryption of the at least some of the homomorphically encrypted data included in the aggregated subset of data. For example, the data requester may request decryption of the homomorphically encrypted data included in the aggregated subset of data after seeing a purchase price. The method 400 may further include providing a decryption key from at least one of the independent data sources to the data requester. The aggregated subset of data may include at least some data from the at least one independent data source that has been homomorphically encrypted and/or the decryption key may include a one-time decryption key.

Alternatively or additionally, the method 400 may further include identifying the independent data sources having homomorphically encrypted data in the aggregated subset of data and notifying the identified independent data sources of the request from the data requester. The identified independent data sources may be notified by sending their respective homomorphically encrypted data to each independent data source or in some other manner. The method 400 may further include receiving re-encrypted data from the identified independent data sources. The re-encrypted data may have the homomorphic encryption removed and may be re-encrypted with a public encryption key provided by the data requester such that the data requester may receive and decrypt the re-encrypted data using a corresponding private key of the data requester. In some embodiments, the re-encrypted data may have the original homomorphic encryption removed and may be re-encrypted with a public homomorphic encryption key provided by the data requester such that the data requester may receive and decrypt the homomorphically re-encrypted data using a corresponding private homomorphic key of the data requester. The results provided to the data requester may include the re-encrypted data (e.g., data re-encrypted with the public (non-homomorphic) encryption key or the public homomorphic encryption key of the data requester) in this and/or other implementations.

In some implementations, the method 400 may further include running one or more cache queries or analyses to identify one or more locations of certain homomorphically encrypted data stored in the repository and storing the one or more locations. All or a portion of the running of the one or more cache queries may implement hardware acceleration. Alternatively or additionally, the method 400 may further include identifying the one or more locations when the data request from the data requester is the same or similar to the one or more cache queries. This may result in quicker data request results.

In some implementations, the method 400 may further include building an index for a single data set (e.g., from one of the data sources 106) or an aggregate data set (e.g., from two or more of the data sources 106). One or more operations associated with building the index may be identified for execution by and offloaded to one or more hardware accelerators, with the output(s) being returned by the hardware accelerator(s) and the index including or being based on the output(s) of the operation(s) executed by the hardware accelerator(s).

In some implementations, the method 400 may further include non-homomorphically encrypting or partially homomorphically encrypting at least a second portion of the data received from the independent data sources. Alternatively, the independent data sources may non-homomorphically encrypt or partially homomorphically encrypt at least a second portion of its respective data before it is provided. By way of example, less sensitive data may be non-homomorphically encrypted or partially homomorphically encrypted. Thus, the first portion of the data received from the independent data sources may have a higher sensitivity level than the second portion of the data received from the independent data sources.

In some implementations, the method 400 may further include identifying from the data request received from the data requester one or more types of data to be identified from the stored data and analyzing the stored data to determine if the one or more types of data is included therein. The one or more types of data to be identified from the stored data may include one or more genetic variants and analyzing the stored data may include determining if the homomorphically encrypted data includes any instances of the one or more genetic variants. Alternatively or additionally, the one or more types of data to be identified from the stored data may include at least one type of genomic data, at least one type of phenotypic data, or a combination of at least one type of genomic data and at least one type of phenotypic data and analyzing the stored data may include determining if the homomorphically encrypted data includes any instances of the at least one type of genomic data, the at least one type of phenotypic data, or a combination of at least one type of genomic data and at least one type of phenotypic data. In some embodiments, the at least one type of phenotypic data includes one or more of demographic information, electronic health record data and derivatives thereof, medical diagnostic codes, billing codes, terms from computational ontologies, patient-reported data, automatically generated data from health wearables or sensors, family history data, and medical imaging raw data or downstream derivative features thereof.

The method 400 implements hardware acceleration for search and/or filtering, e.g., operations or algorithms associated with searching and/or filtering homomorphically encrypted data and/or other data may be offloaded to one or more hardware accelerators according to the method 400. More generally, embodiments herein may implement hardware acceleration for any operation(s), algorithm(s), or portion thereof including for search, filtering, analysis (e.g., mathematical functions or operations, statistical tests, training or applying statistical (machine learning (ML)) models, etc.), and/or other operations, algorithms, or portions thereof.

In these and other embodiments, the method 400 may be more broadly described as follows. At block 402, the method 400 may include receiving, at a repository, a command or request to process data in a repository that includes at least some homomorphically encrypted data. For example, the command or request may be a command or request to search, filter, analyze (e.g., apply mathematical function(s) or operation(s), perform statistical test(s), train or apply statistical (e.g., machine learning model(s))), or otherwise process the data in the repository. At block 404, the method may include processing the stored data without decrypting the homomorphically encrypted data to calculate the result of a computational operation. In more detail, block 404 may include one or more of blocks 408, 410, 412, and 414, which may respectively include identifying an operation executable by a hardware accelerator to complete the processing, dispatching a command to a hardware accelerator to execute the identified operation, executing the identified operation at the hardware accelerator, and receiving (e.g., at the CPU) an output of the operation executed by the hardware accelerator. At block 406, the method may include returning the result of the computational operation, which result may include or be based on the output of the operation executed by the hardware accelerator. In some embodiments, the returned data may be aggregated with data returned or derived (e.g., in the same, similar, or different manner than herein-described) from one or more other repositories.

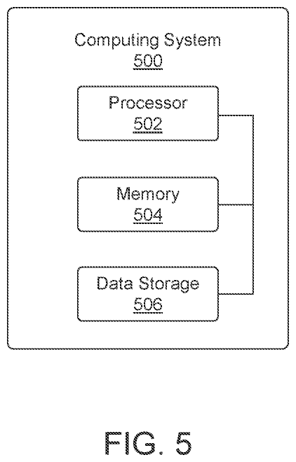

FIG. 5 illustrates a block diagram of an example computing system 500, arranged in accordance with at least one embodiment described herein. The computing system 500 may be configured according to at least one embodiment of the present disclosure and may be an example of computing systems that may include or be part of one or more elements of the system 100 of FIG. 1A. For example, the system 100 may include one or more computing systems 400. More particularly, the repository 102 may include a computing system 500, the data requester 104 may include a computing system 500, and each of the independent data sources 106, 108, 110 may include a computing system.

The computing system 500 may include a processor 502, a memory 504, and a data storage 506. The processor 502, the memory 504, and the data storage 506 may be communicatively coupled. The processor 502 may include, be included in, or correspond to the processor system 124 of FIGS. 1A and 1B, and the data storage 506 may include, be included in, or correspond to one or both of the databases 112, 118 of FIG. 1A.

In general, the processor 502 may include any suitable special-purpose or general-purpose computer, computing entity, or processing device including various computer hardware or software modules and may be configured to execute instructions stored on any applicable computer-readable storage media. For example, the processor 502 may include a microprocessor, a microcontroller, a digital signal processor (DSP), a GPU, an ASIC, an FPGA, or any other digital or analog circuitry configured to interpret and/or to execute program instructions and/or to process data. Although illustrated as a single processor in FIG. 5, the processor 502 may include any number of processors configured to, individually or collectively, perform or direct performance of any number of operations described in the present disclosure. Additionally, one or more of the processors may be present on one or more different electronic devices, such as different servers.

In some embodiments, the processor 502 may be configured to interpret and/or execute program instructions and/or process data stored in the memory 504, the data storage 506, or the memory 504 and the data storage 506. In some embodiments, the processor 502 may fetch program instructions from the data storage 506 and load the program instructions in the memory 504. After the program instructions are loaded into memory 504, the processor 502 may execute the program instructions.

The memory 504 and the data storage 506 may include computer-readable storage media for carrying or having computer-executable instructions or data structures stored thereon. Such computer-readable storage media may include any available media that may be accessed by a general-purpose or special-purpose computer, such as the processor 502. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store program code in the form of computer-executable instructions or data structures and which may be accessed by a general-purpose or special-purpose computer. In these and other embodiments, the term “non-transitory” as explained herein should be construed to exclude only those types of transitory media that were found to fall outside the scope of patentable subject matter in the Federal Circuit decision of In re Nuijten, 500 F.3d 1346 (Fed. Cir. 2007). Combinations of the above may also be included within the scope of computer-readable media.

Modifications, additions, or omissions may be made to the computing system 500 without departing from the scope of the present disclosure. For example, in some embodiments, the computing system 500 may include any number of other components that may not be explicitly illustrated or described.

For instance, in some embodiments, the computing system 500 may include a communication unit that includes any component, device, system, or combination thereof that is configured to transmit or receive information over a network. In some embodiments, the communication unit may communicate with other devices at other locations, the same location, or even other components within the same system. For example, the communication unit may include a modem, a network card (wireless or wired), an optical communication device, an infrared communication device, a wireless communication device (such as an antenna), and/or chipset (such as a Bluetooth device, an 802.6 device (e.g., Metropolitan Area Network (MAN)), a WiFi device, a WiMax device, cellular communication facilities, or others), and/or the like. The communication unit may permit data to be exchanged with a network and/or any other devices or systems described in the present disclosure. For example, the communication unit may allow the system 500 to communicate with other systems, such as computing devices and/or other networks.

Additionally or alternatively, the computing system 500 may include one or more user interfaces in some embodiments. The user interfaces may include any system or device to allow a user to interface with the system 500. For example, the interfaces may include a mouse, a track pad, a keyboard, and/or a touchscreen, among other devices or systems. The interfaces may also include a graphical user interface that may be presented on a display that may be included with the computing system 500. The display may be configured as one or more displays, like an LCD, LED, or other type of display. The display may be configured to present content such as video, text, user interfaces, and other data as directed by the processor.

As indicated above, the embodiments described in the present disclosure may include the use of a special purpose or general purpose computer (e.g., the processor 502 of FIG. 5) including various computer hardware or software modules, as discussed in greater detail below. Further, as indicated above, embodiments described in the present disclosure may be implemented using computer-readable media (e.g., the memory 504 or data storage 506 of FIG. 5) for carrying or having computer-executable instructions or data structures stored thereon.

In some embodiments, the different components, modules, engines, and services described herein may be implemented as objects or processes that execute on a computing system (e.g., as separate threads). Some of the systems and methods described in the present disclosure are generally described as being implemented in software (stored on and/or executed by general purpose hardware); specific hardware implementations or a combination of software and specific hardware implementations are also disclosed and contemplated.

In some implementations, data from independent sources may be first encrypted with homomorphic encryption prior to aggregation in a repository. For example, the independent sources may encrypt the data before forwarding it to the repository, and the encryption may involve full homomorphic encryption or partial homomorphic encryption. Queries or analyses against the aggregate data received from a data requester may be performed without decrypting the data and using hardware acceleration. The encrypted result is then delivered to the data requester, and one-time decryption keys are passed from the independent data source(s) to the data requester.

As an alternative to one-time decryption keys, the aggregate encrypted result may also be subdivided according to the source of each encrypted output data entry. In this case, the encrypted results may be returned to each respective independent data source holding a key for the relevant encrypted data, which will in turn decrypt the results, encrypt the results with a public key provided by the data requester, and securely return the encrypted result to the repository for forwarding to the data requester, who can decrypt with their private key.

In another embodiment, with or without utilizing homomorphic encryption, a central node or repository receives inbound data requests from one or more data requesters, translates the data requests into a set of all possible resulting data, and passes the modified data requests to one or more independent data sources or repositories. The independent data sources or repositories then execute and log the data requests, and each independently return their results to the repository, which in turn returns aggregate results to the data requester. If genomic data is involved for example, input filter-based data requests of genomic annotation parameters may first query or analyze an aggregate set of all possible variants (whether universal or specific to a given data set) at the central node. This initial data request is then translated into a set of all possible genomic variants matching input criteria. Individual data sources are then queried as to whether they contain any samples harboring genetic variants in the intermediate set. Results are likewise first returned to the central node prior to aggregate analysis and return of results to data requester.

In another embodiment, the subject matter disclosed herein may be used in instances where a vendor may list physical assets for sale (such as tissue samples, with or without any associated metadata) without divulging inventory (or any associated metadata) to external parties other than the purchaser for any given specific transaction. Metadata cataloguing inventory contents is aggregated into the context of a search service that may search the inventory contents (or associated metadata) of one or many vendors. Data requesting parties may search across the system (using any combination of specific, general, or artificial intelligence-generated criteria) for specific assets or categories of assets, retrieving information as to whether such assets exist within the searchable system at large. Pricing information for purchasing any such assets resulting from a data request (with or without associated metadata) may be provided to the data requesting party. In the event a decision to purchase is made, a transaction is facilitated, and fulfillment of the purchased assets (with or without associated metadata) may be arranged such that no third parties (including any potential centralized search system service providers) become aware of the specific contents of the purchase (and/or any associated metadata).

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used in the present disclosure to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited in the present disclosure are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method, comprising:
receiving, at a central processing unit (CPU), a data request from a data requester to search or filter data in a repository, wherein at least a first portion of the data is homomorphically encrypted;
analyzing the stored data without decrypting the homomorphically encrypted data to determine an aggregated subset of data relevant to the data request, the aggregated subset of data comprising at least some of the homomorphically encrypted data, the analyzing including:
dispatching, from the CPU, a command to a hardware accelerator to execute an operation on the homomorphically encrypted data;
executing, at the hardware accelerator, the operation on the homomorphically encrypted data; and
receiving, at the CPU, an output of the execution of the operation by the hardware accelerator, wherein the aggregated subset of data is based on the output; and
providing data request results that include or are derived from the aggregated subset of data to the data requester.

2. The method of claim 1, wherein the hardware accelerator comprises a graphics processing unit (GPU).

3. The method of claim 1, wherein the hardware accelerator comprises a field-programmable gate array (FPGA).

4. The method of claim 1, wherein the hardware accelerator comprises an application-specific integrated circuit (ASIC).

5. The method of claim 1, wherein the aggregated subset of data includes homomorphically encrypted data received from at least two of the independent data sources.

6. The method of claim 1, further comprising receiving a decryption request from the data requester for decryption of the at least some of the homomorphically encrypted data included in the aggregated subset of data.

7. The method of claim 6, further comprising providing a decryption key from at least one of the independent data sources to the data requester.

8. The method of claim 7, wherein the aggregated subset of data includes at least some data from the at least one independent data source that has been homomorphically encrypted.

9. The method of claim 7, wherein the decryption key is a one-time decryption key.

10. The method of claim 6, further comprising:
identifying the independent data sources having homomorphically encrypted data in the aggregated subset of data;
notifying the identified independent data sources of the data request; and
receiving re-encrypted data from the identified independent data sources, the re-encrypted data being re-encrypted with a public encryption key provided by the data requester.

11. The method of claim 1, further comprising:
running one or more cache queries to identify one or more locations of certain homomorphically encrypted data stored in the repository;
storing the one or more locations; and
identifying the one or more locations when the data request from the data requester is the same or similar to the one or more cache queries.

12. The method of claim 1, wherein:
at least a second portion of the data received from the number of independent data sources is encrypted; and
the first portion of the data received from the number of independent data sources has a different sensitivity level than the second portion of the data received from the number of independent data sources.

13. The method of claim 1, further comprising identifying from the data request received from the data requester one or more types of data to be identified from the stored data and analyzing the stored data to determine if the one or more types of data is included therein.

14. The method of claim 13, wherein the one or more types of data to be identified from the stored data includes at least one type of genomic data, at least one type of phenotypic data, or a combination of at least one type of genomic data and at least one type of phenotypic data, and analyzing the stored data includes determining if the homomorphically encrypted data includes any instances of the at least one type of genomic data, the at least one type of phenotypic data, or a combination of at least one type of genomic data and at least one type of phenotypic data.

15. The method of claim 14, wherein the at least one type of genomic data includes a genetic variant.

16. The method of claim 14, wherein the at least one type of phenotypic data includes one or more of demographic information, electronic health record data and derivatives thereof, medical diagnostic codes, billing codes, terms from computational ontologies, patient-reported data, automatically generated data from health wearables or sensors, family history data, and medical imaging raw data or downstream derivative features thereof.

17. The method of claim 1, wherein the stored data includes information relating to physical assets for sale.

18. The method of claim 1, wherein the stored data includes at least one type of phenotypic data, the phenotypic data including one or more of demographic information, electronic health record data and derivatives thereof, medical diagnostic codes, billing codes, terms from computational ontologies, patient-reported data, automatically generated data from health wearables or sensors, family history data, and medical imaging raw data or downstream derivative features thereof.

19. The method of claim 1, wherein the stored data includes financial information, the financial information including health insurance information, billing information, account balance information, credit information, credit score information, payment information, or any combination of the foregoing.

20. The method of claim 1, wherein the first portion of the received data is homomorphically encrypted before receipt from the number of independent data sources.

21. The method of claim 1, wherein the stored data includes at least one type of genomic data, at least one type of phenotypic data, or a combination of at least one type of genomic data and at least one type of phenotypic data.

22. A system comprising:
a central processing unit (CPU);
a hardware accelerator; and
one or more non-transitory computer-readable media containing instructions which, in response to being executed by the CPU, cause the system to perform or control performance of operations comprising:
receiving, at the CPU, a data request from a data requester to search or filter data in a repository, wherein at least a first portion of the data is homomorphically encrypted;
analyzing the stored data without decrypting the homomorphically encrypted data to determine an aggregated subset of data relevant to the data request, the aggregated subset of data comprising at least some of the homomorphically encrypted data, the analyzing including:
dispatching, from the CPU, a command to the hardware accelerator to execute an operation on the homomorphically encrypted data;
executing, at the hardware accelerator, the operation on the homomorphically encrypted data; and
receiving, at the CPU, an output of the execution of the operation by the hardware accelerator, wherein the aggregated subset of data is based on the output; and
providing data request results that include or are derived from the aggregated subset of data to the data requester.

23. The system of claim 22, wherein the hardware accelerator comprises a graphics processing unit (GPU).

24. The system of claim 22, wherein the hardware accelerator comprises a field-programmable gate array (FPGA).

25. The system of claim 22, wherein the hardware accelerator comprises an application-specific integrated circuit (ASIC).

26. One or more non-transitory computer-readable media containing instructions which, in response to being executed by a central processing unit (CPU), cause a system that includes the CPU and a hardware accelerator to perform or control performance of operations comprising:
receiving, at the CPU, a data request from a data requester to search or filter data in a repository, wherein at least a first portion of the data is homomorphically encrypted;
analyzing the stored data without decrypting the homomorphically encrypted data to determine an aggregated subset of data relevant to the data request, the aggregated subset of data comprising at least some of the homomorphically encrypted data, the analyzing including:
dispatching, from the CPU, a command to the hardware accelerator to execute an operation on the homomorphically encrypted data;
executing, at the hardware accelerator, the operation on the homomorphically encrypted data; and
receiving, at the CPU, an output of the execution of the operation by the hardware accelerator, wherein the aggregated subset of data is based on the output; and
providing data request results that include or are derived from the aggregated subset of data to the data requester.

27. A method, comprising:
receiving, at a central processing unit (CPU), a request from a requester to process data in a repository, wherein at least a first portion of the data is homomorphically encrypted;
processing the data without decrypting the homomorphically encrypted data to calculate a result of a computational operation, the processing including:
dispatching, from the CPU, a command to a hardware accelerator to execute an operation on the homomorphically encrypted data to complete the processing;
executing, at the hardware accelerator, the operation on the homomorphically encrypted data; and
receiving, at the CPU, an output of the execution of the operation; and
returning the result of the computational operation, wherein the result of the computational operation includes or is based on the output of the operation executed by the hardware accelerator.

28. The method of claim 27, further comprising aggregating the returned result with data returned or derived from another repository.

29. One or more non-transitory computer-readable media containing instructions which, in response to being executed by a central processing unit (CPU), cause a system that includes the CPU and a hardware accelerator to perform or control performance of the method of claim 27.
